(19) United States
(12) Patent Application Publication
(10) Pub. No.: US 2015/0012245 A1
(43) Pub. Date: Jan. 8, 2015

(54) MEASUREMENT APPARATUS AND METHOD

(71) Applicant: Taylor Hobson Limited, Leicester, Leicestershire (GB)

(72) Inventor: Shaojun Xiao, Leicester (GB)

(73) Assignee: Taylor Hobson Limited, Leicester, Leicestershire (GB)

(21) Appl. No.: 14/378,152

(22) PCT Filed: Feb. 13, 2013
(86) PCT No.: PCT/GB2013/050339

§ 371 Date: Aug. 12, 2014

(30) Foreign Application Priority Data
Feb. 13, 2012 (GB) 1202456.8

(51) Int. Cl. G01M 11/02; G01B 21/04; G01B 21/20

(52) U.S. Cl. CPC G01M 11/025; G01B 21/20; G01B 21/04
USPC 702/168

(57) ABSTRACT

A computer implemented method of determining the surface shape of an aspheric object using a metrological apparatus includes positioning the object on a support surface of a turntable so that an axis of the object is tilted with respect to the axis of rotation of the turntable; using a measurement probe to make a first measurement of the object; rotating the turntable; after rotation of the turntable, using a measurement probe to make a second measurement of the object, diametrically opposite the first measurement, estimating a first angle based on fitting the first measurement data using a surface model including: a dependency on the axis tilt angle and a dependency on the radius of the base of the object; estimating a second angle based on fitting the second measurement data to the surface model; and determining the tilt angle based on the first angle and the second angle.

This invention relates to a method and apparatus for performing form measurements of a surface, and more particularly to methods and apparatus for measuring the surface form of aspheric surfaces with stylus profilometers.

In optical components, form errors having length scales of a fraction of a wavelength can cause significant unwanted aberrations. Thus the precise measurement of optical components is particularly important for quality control of such components. High precision measurement of aspheric optical components having steeply curving surfaces presents particular challenges. To evaluate the aspheric form error, an aspheric component is centred and levelled, and a number of diagonal profiles are measured across the assumed aspheric axis. The key problem for this method is that the contact angle between the measurement stylus and the curved aspheric surface swings from positive to negative angle. As the radius of the aspheric part gets smaller, the contact angle at the both ends gets larger, and may be as high as 60° or 70° whilst the recommend contact angle for any stylus instrument is less than 35°. When making a “downhill” measurement, the contact angle is negative and the measurements are prone to flick error. To reduce the contact angle, the traverse unit is tilted and two half profiles are measured. This raises the problem of how to align two measured half profiles.

Previous work by the Applicant has addressed this. The commercial product Talysurf PGI 3D Optics (manufactured by Ametek—Taylor Hobson of 2 New Star Road, Leicester LE4 9JD, UK) applies analysis disclosed in International Patent Application WO 2010/043906 (which is hereby incorporated by reference) to match up two half profiles and join them together in order to determine the position of the apex of an aspheric workpiece.

The inventor in this case has appreciated that a different approach is possible and may provide certain advantages. Aspects and examples of the invention are set out in the claims. Given a measurement of a full profile fitting a surface model to the measurement data is straightforward because the positional parameters are determined by the profile's symmetrical form (e.g. the axis is derivable from symmetry). In these circumstances the estimates of axis and radius are decoupled. However, where only half the profile is measured, the position of the axis is not known, and there are form errors in the surface of the aspheric workpiece the estimates of the base radius of the component and the estimates of the tilt angle of the component are related. An attempt to fit for one of the two parameters is therefore confounded by uncertainty in the other. In other words, the fitted positional parameters such as the axis tilt angle, and the dimensional parameters, such as the base radius are not independent. Fitting an aspheric surface model to measured data is a non-linear process so there is no easy way analytically to separate this cross talk between the two parameters. It is challenging to find both the position of the optical axis of an aspheric component and its radial dimension at the same time from half profile measurements.

In an aspect there is provided a computer implemented method of determining the surface shape of an aspheric object using a metrological apparatus, the method comprising: positioning the object on a support surface of a turntable of the metrological apparatus so that an axis of the object is tilted with respect to the axis of rotation of the turntable by a tilt angle, α; using a measurement probe to make a first measurement of the object to provide first measurement data; rotating the turntable; after rotation of the turntable, using a measurement probe to make a second measurement of the object, diametrically opposite the first measurement, to provide second measurement data, estimating a first angle, γ₁, based on fitting the first measurement data using a surface model comprising: a dependency on the axis tilt angle, α, and a dependency on the radius, R, of the base of the object; estimating a second angle, γ₂, based on fitting the second measurement data to the surface model; determining the axis tilt angle based on the tilt angle of the probe and at least one of the first angle and the second angle. In some examples this method comprises determining an average of the first angle and the second angle and, in the event that the average is equal to a tilt angle of the measurement probe, determining the axis tilt angle based on the tilt angle of the probe and at least one of the first angle and the second angle.

Estimating the first angle may comprise estimating the radius, R, of the base of the object, and optimising the estimate of the radius by fitting the surface model to the first and/or second measurement data, and determining the first and/or second angle based on the surface model and the optimised estimate of the radius. For example, fitting the first or second measurement data may comprise using a fixed estimate of the axis tilt angle, α, whilst varying the estimate of radius R to optimise the fit of the surface model to said measurement data. The optimisation may comprise determining a Jacobian, J, according to the surface model, wherein the Jacobian

$$J = [ \begin{matrix}1 & \frac{\partial {d}_{1}}{\partial R} \\ 1 & \frac{\partial {d}_{2}}{\partial R} \\ ⋮ & ⋮ \\ 1 & \frac{\partial {d}_{m}}{\partial R}\end{matrix} ] ,$$

where dᵢ indicates the difference between a measured point in the measurement data, and the fitted surface model (e.g an aspheric profile). For example dᵢ=hᵢ−\hat{z}ᵢ, where, hᵢ=z(\hat{x}ᵢ) e.g. the measured surface height at that position.

In some examples,

$$\frac{\partial {d}_{i}}{\partial R} = \frac{- shape * {x}^{2}}{( R + \sqrt{{R}^{2} - ( 1 + k ) * {x}^{2}} ) \sqrt{{R}^{2} - ( 1 + k ) * {x}^{2}}} .$$

This may enable the radius of the base of the component to be determined based on a linear least squares system. For example

$${J}_{m \times 2} [ \begin{matrix}{p}_{D C} \\ {p}_{R}\end{matrix} ] = - {d}_{m \times 1} where d = {[ {d}_{1} , {d}_{2} , … , {d}_{m} ]}^{T} ,$$

This may be used to update estimates of the radius, R, and the central position of the aspheric profile, z₀, according to:

$$[ \begin{matrix}{z}_{0} \\ R\end{matrix} ] = [ \begin{matrix}{z}_{0} \\ R\end{matrix} ] + [ \begin{matrix}{p}_{D C} \\ {p}_{R}\end{matrix} ]$$

Estimating the first angle and/or second angle may comprise estimating the axis tilt angle, α, and optimising the estimate of the axis tilt angle, α, based on fitting the surface model to the first and/or second measurement data respectively, and determining the first angle c and/or second angle based on the surface model and the optimised estimate of the axis tilt angle, α. These examples may comprise estimating the aspheric center position, x₀, z₀, and using the estimated aspheric center position in optimising the estimate of the axis tilt angle. Accordingly, optimising the estimate of the axis tilt angle may comprise optimising the estimate of aspheric center position, x₀, z₀.

The optimisation may be based on a merit function based on the first measurement data and the second measurement data and the surface model, wherein the merit function includes parameters to account for the axis tilt angle, α, and the center position (x₀, z₀) of the aspheric object (e.g. the offset of the aspheric object from alignment on the spindle axis). The parameterisation may be based on the co-ordinate transform:

$$[ \begin{matrix}\hat{x} \\ \hat{z}\end{matrix} ] = [ \begin{matrix}cs & - sn \\ sn & cs\end{matrix} ] ( [ \begin{matrix}x \\ z\end{matrix} ] - [ \begin{matrix}{x}_{0} \\ {z}_{0}\end{matrix} ] ) , \\ where \\ [ \begin{matrix}x \\ z\end{matrix} ] = r , \qquad ( 2 )$$

cs=cos(α), and
sn=sin(α).

Thus,

\hat{x}=cs*(x−x₀)−sn*(z−z₀)

\hat{z}=sn*(x−x₀)+cs*(z−z₀)

This optimisation may comprise determining a Jacobian, J, of the model and measured data according to:

$$J = [ \begin{matrix}\frac{\partial {d}_{1}}{\partial α} & \frac{\partial {d}_{1}}{\partial {x}_{0}} & \frac{\partial {d}_{1}}{\partial {z}_{0}} \\ \frac{\partial {d}_{2}}{\partial α} & \frac{\partial {d}_{2}}{\partial {x}_{0}} & \frac{\partial {d}_{2}}{\partial {z}_{0}} \\ ⋮ & ⋮ & ⋮ \\ \frac{\partial {d}_{m}}{\partial α} & \frac{\partial {d}_{m}}{\partial {x}_{0}} & \frac{\partial {d}_{m}}{\partial {z}_{0}}\end{matrix} ]$$

wherein,

$$\frac{\partial z}{\partial α} = \hat{x} and \frac{\partial \hat{x}}{\partial α} = - \hat{z}$$

$$\frac{\partial {d}_{i}}{\partial α} = \frac{\partial h}{\partial x} \times \frac{\partial \hat{x}}{\partial α} - \frac{\partial \hat{z}}{\partial α} = - ( hd \times \hat{z} + \hat{x} )$$

$$\frac{\partial {d}_{i}}{\partial {x}_{0}} = \frac{\partial h}{\partial x} \times \frac{\partial \hat{x}}{\partial {x}_{0}} - \frac{\partial \hat{z}}{\partial {x}_{0}} = - ( hd \times cs - sn )$$

$$\frac{\partial {d}_{i}}{\partial {z}_{0}} = \frac{\partial h}{\partial x} \times \frac{\partial \hat{x}}{\partial {z}_{0}} - \frac{\partial \hat{z}}{\partial {z}_{0}} = hd \times sn + cs ,$$

and where m=the number of measured data points;
cs=cos(α);
sn=sin(α); and
hd=hd(\hat{x})

The first angle γ₁ may be based on the sum of the tilt angle of the measurement probe and a tilt angle α₁, determined from fitting the surface model to the first measurement data. The second angle γ₂ is based on the sum of the tilt angle of the measurement probe and a tilt angle α₂, determined from fitting the surface model to the first measurement data. Where angles oppose each other they are of opposite sign. A tilt angle of zero degrees indicates alignment with the axis of rotation of the turntable.

In some examples fitting the measurement data comprises treating the radius as constant and fitting to determine the axis tilt angle. In some examples fitting the measurement data comprises treating the axis tilt angle as constant and fitting to determine the radius. In some examples the determined axis tilt angle may be used to determine the radius of the base of the object, for example determining the radius of the base of the object comprises fitting the surface model to the first measurement data and/or the second measurement data using the determined axis tilt angle.

In some cases the measurement probe of the metrological apparatus is aligned with the axis of rotation of the turntable but in most cases it is tilted the measurement probe of the metrological apparatus may be tilted with respect to the axis of rotation of the turntable by an angle less than 90°, for example less than 70° and preferably by between 20° and 60°. Any tilt angle may be used.

In some examples the method comprises determining the surface form of the object based on the surface model. Preferably the surface model comprises a polynomial function for modelling deviations of the surface of the object from aspheric form. The surface model may comprise a model of the form

$$z = \frac{shape * {x}^{2}}{R + \sqrt{{R}^{2} - ( 1 + k ) * {x}^{2}}} + {\sum }_{i = 1}^{20} {a}_{i} {x}^{i}$$

where:
x is the radial distance from the axis of the aspheric object;
z is the corresponding vertical distance parallel with the rotation axis;
R is the base radius of the object;
k is the conic constant of the object surface;
shape is a sign parameter indicating whether the surface is convex or concave and the coefficients aᵢ describe the polynomial function.

In some examples the tilt angle of the measurement probe is determined based on a measurement of a reference surface. For example, determining the tilt angle of the probe may comprise using the measurement probe to make a first measurement of a reference surface to provide first reference measurement data; rotating the turntable; after rotation of the turntable, using the measurement probe to make a second measurement of the object to provide second reference measurement data; and determining the tilt angle of the measurement probe based on the first and second measurement data. The reference surface may be provided by an optical flat

In an aspect there is provided a metrological apparatus for determining the surface shape of an aspheric object, the method comprising: a turntable having a support surface for supporting an object to be measured wherein the turntable is operable to rotate about a rotation axis; a measurement probe operable to traverse a measurement path across the surface of the object to be measured to provide measurement data; a controller operable to control the measurement probe to traverse a first measurement path to provide first measurement data and to rotate the turntable and, after rotation of the turntable, to control the measurement probe to traverse a second measurement path to provide second measurement data, wherein the first measurement path and the second measurement path are diametrically opposite each other on the surface of the object, and a data processor configured to: estimate a first angle, γ₁, based on fitting the first measurement data using a surface model comprising: a dependency on the axis tilt angle, α, and a dependency on the radius, R, of the base of the object; estimate a second angle, γ₂, based on fitting the second measurement data to the surface model; and to determine an average of the first angle and the second angle and, to determine the axis tilt angle based on the tilt angle of the probe and at least one of the first angle and the second angle. The data processor of the metrological apparatus may be configured to any of the methods described herein.

In an aspect there is provided a data processor for a metrological instrument, wherein the processor is configured to: receive first measurement data and second measurement data, wherein the first and second measurement data each provide a part of a measurement of the profile of the surface of an aspheric object to be measured; estimate a first angle, γ₁, based on fitting the first measurement data using a surface model comprising: a dependency on the axis tilt angle, α, and a dependency on the radius, R, of the base of the object; estimate a second angle, γ₂, based on fitting the second measurement data to the surface model; and to determine an average of the first angle and the second angle and, to determine the axis tilt angle based on the tilt angle of the probe and at least one of the first angle and the second angle. In some examples, in the event that a termination condition is not met, the processor is configured to update an estimate of the axis tilt angle to be used in the surface model and to iterate the estimating and determining steps. The termination condition may comprise determining that the average of the first angle and the second angle is equal to a tilt angle of the measurement probe.

Embodiments of the invention provide a computer program product comprising program instructions operable to program a processor to perform a method according to any one described herein. Computer program products may be provided in the form of computer readable media storing the program instructions and may also be provided by a signal or network message carrying the program instructions.

Embodiments of the invention will now be described, by way of example only, with reference to the accompanying drawings, in which:

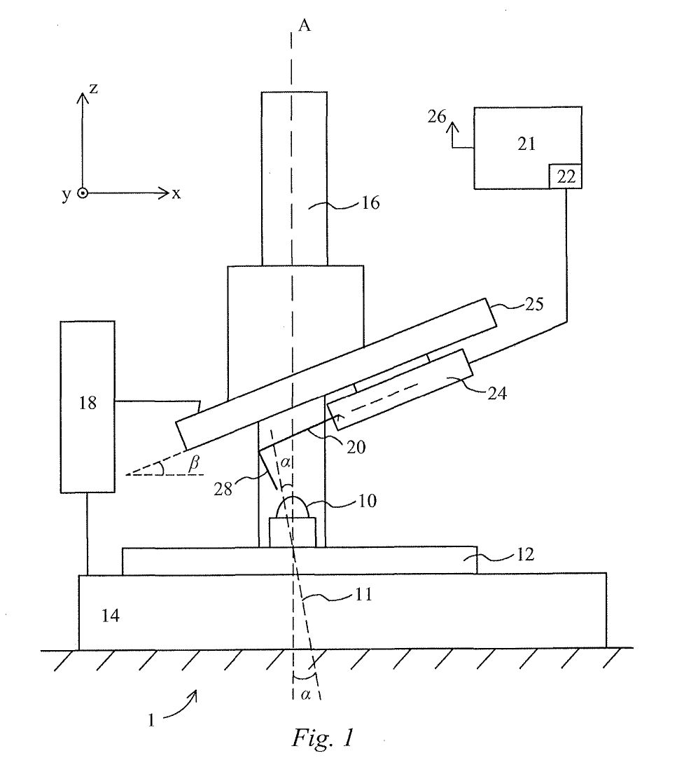

FIG. 1 shows a schematic view of a measurement apparatus and a workpiece to be measured;

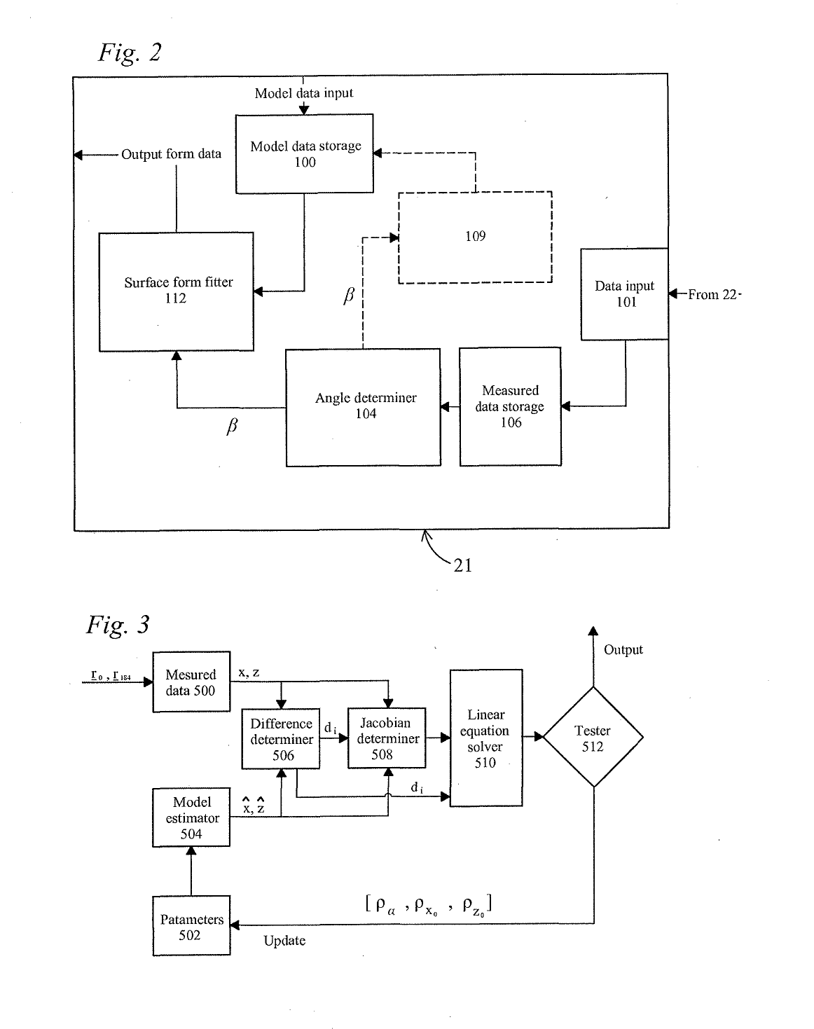

FIG. 2 shows a schematic view of a data processing component of the apparatus in FIG. 1;

FIG. 3 shows a schematic view of functionality of the data processing component of FIG. 2;

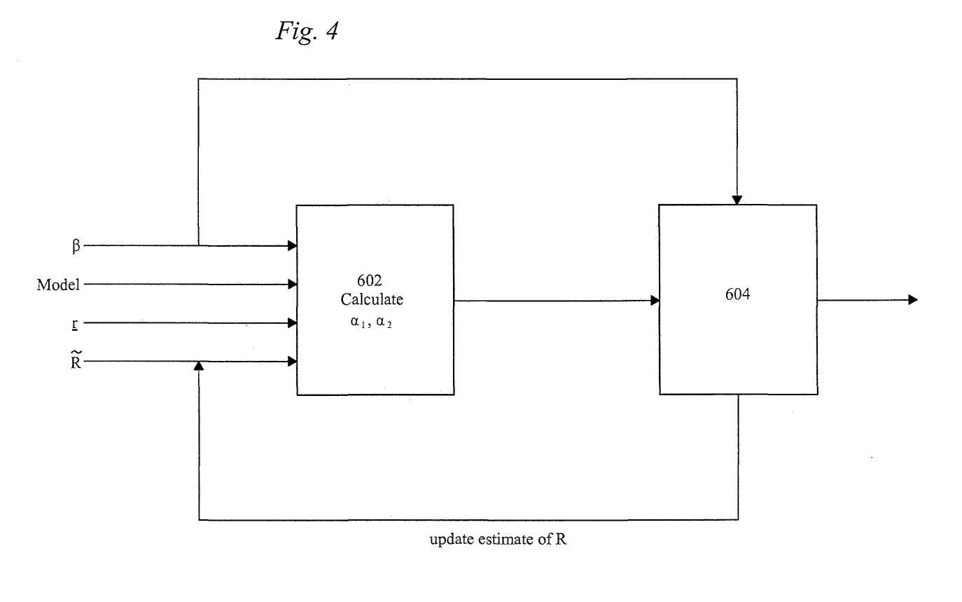

FIG. 4 shows an optional addition or alternative to the apparatus of FIG. 3;

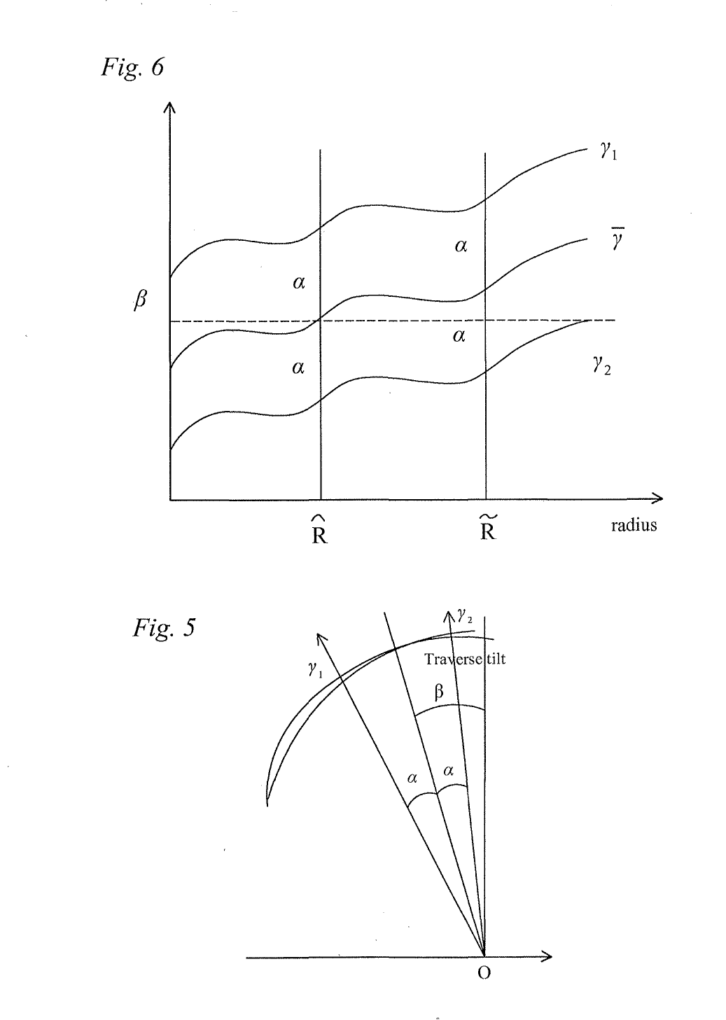

FIG. 5 shows an illustrative plot of the relationship between radius and estimated axis tilt angle;

FIG. 6 illustrates a relationship between traverse tilt angle and axis tilt angle;

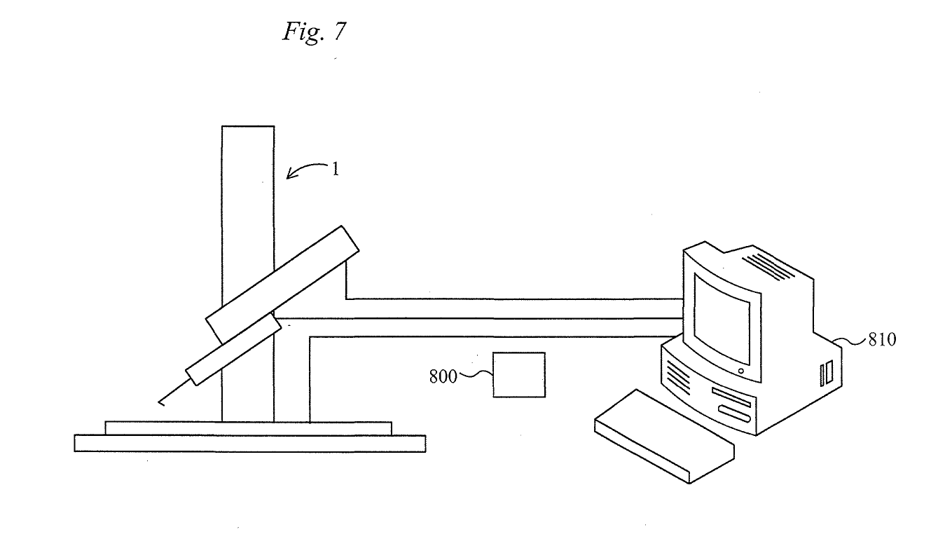

FIG. 7 shows a computer apparatus and computer program product;

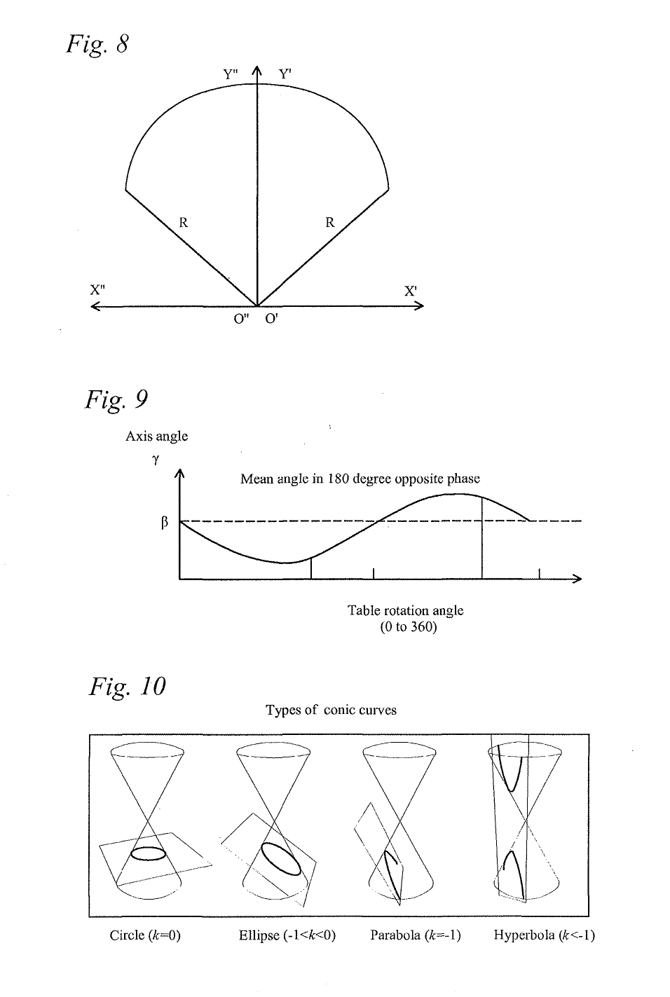

FIG. 8 shows a diametrical profile from a spherical component;

FIG. 9 shows a schematic illustration of a plot of axis angle vs. table rotation; and

FIG. 10 illustrates different types of conic curves.

In overview, the purpose of the apparatus shown in FIG. 1 is the measurement of the form of the surface of a workpiece. This is done by tracing a stylus along a measurement path on the surface of the workpiece whilst measuring displacement of the stylus.

Before discussing the apparatus in detail, to put the description that follows in context, the outline of its method of operation is briefly discussed. After initial calibrations and instrument set-up (described in detail below) a “half profile” of a component is measured by tracing a measurement path between its crest and its outer edge, for example along half the diameter of the component. The component is then rotated, generally through 180°, and a second half profile is measured. These two measurement steps provide two separate “half profiles”. The nature of these measurements, and the resulting data, is such that the true radius of the component and the true position of the crest (and hence the optical axis of the component) is not known with the desired level of accuracy. However, components to be measured are typically manufactured to conform to a known aspheric form (such as defined in equation (1) below) and so it is possible to fit a surface model to the data to determine these parameters. A problem arises because the parameters to be fitted, namely the radius and the axis position are not independent of one another. To address this, an a priori estimate of the radius can be used to enable the known surface form to be fitted separately to each one of the measured half profiles.

These two fitting procedures generate two angles associated with the relative rotation of the data. The inventors have appreciated that it is possible to derive the true axis tilt angle from these measured angles because they will be symmetric about the stylus. In other words, the open angle between the two fitted angles will be bisected by the traverse tilt angle.

FIG. 1 shows a measurement apparatus 1 comprising a turntable 12 which is rotatable about a spindle axis 16 by a rotation drive 14. An aspheric optical component 10, the workpiece to be measured, is disposed on the turntable 12. The optical axis 11 of the workpiece 10 is tilted with respect to the spindle axis 16 of the turntable 12 by an angle, γ.

The measuring apparatus 1 comprises a stylus 28 carried on a stylus arm 20. The stylus arm is mounted on a mover 25 and coupled to a displacement measurer 24. The displacement measurer 24 is coupled to an interface 22 of a surface form determiner 21. The surface form determiner 21 comprises an output 26 for outputting surface measurement data to a resource. A movement controller 18 is coupled to the rotation drive 14 and to the mover 25. The mover 25 is operable to move the stylus arm 20 so that the stylus traverses a measurement path across the turntable 12. The displacement measurer 24 is configured to measure displacements of the stylus 28 as the mover 25 causes the stylus 28 to traverse the workpiece. The measured displacement of the stylus 28 is logged along the traverse measurement path.

The displacement measurer 24 is further configured to communicate measured displacements to the interface 22. The interface 22 is arranged to convert the measured displacements into data for processing, and is coupled to provide the data to the surface form determiner 21.

The structure and operation of the surface form determiner 21 is described in more detail below with reference to FIG. 2. In summary the surface form determiner is configured to receive measurement data and to process it to provide a measurement of the surface form of the workpiece 10.

The movement controller 18 is operable to receive movement instructions (e.g. from a user interface or control system such as that shown in FIG. 7) and to control the rotation drive 14 and the mover 25 in accordance with those instructions. Examples of movement instructions include instructions to rotate the turntable 12 about the spindle axis 16 by a selected angle or to trace a measurement path using the stylus 28. In this regard, the movement controller 18 is operable to control the mover 25 to provide displacement of the stylus 28 in a measurement direction, parallel to the stylus and in a second direction, perpendicular to the stylus. To enable the stylus more accurately to measure components with steeply curving sides and/or a high degree of aspheric departure, the stylus 28 is tilted with respect to the turntable at an angle, β so that the contact angle between the stylus and the surface to be measured is closer to 0° (where a contact angle of 0° would indicate that the stylus is perpendicular to the surface it is in contact with).

The improvement in contact angle provided by the tilt on one side of the workpiece is reversed on the other side of the workpiece so tilting the stylus in this way means that it is often not possible to trace a full profile of a workpiece 10 (e.g. across a full diameter). Thus, in operation the stylus 28 is controlled by the mover 25 and the movement controller 18 to measure the workpiece along one half of a complete span of its diameter. The movement controller 18 then controls the rotation drive 14 to rotate the turntable through 180° and the half-profile measurement is then repeated on the other side of the workpiece.

The inventors in this case have appreciated that an efficient way to use the measured data to provide accurate form measurements is to determine (1) the radius of the workpiece and (2) the tilt angle of the optical axis of the workpiece with respect to the spindle axis of the measurement apparatus. The turntable 12 may be mounted on any rotatable mounting for example such as an air bearing spindle. The rotation drive 14 may comprise an electric motor or a stepper motor or any rotary drive coupled to rotate the turntable about its spindle axis.

The mover 25 may comprise any appropriate electromechanical actuator, such as a piezoelectric device and/or a linear stepper motor. The displacement measurer 24 may comprise a phase grating interferometer for example such as the type described in U.S. Pat. No. 5,517,307, which is hereby incorporated by reference. The interface 22 may comprise an analogue-to-digital converter for converting analogue signals from the displacement measurer 24 into digital signals for processing by the surface form determiner. In some cases the displacement measurer 24 itself may be configured to provide a digital output or the surface form determiner 21 may be configured to receive analogue signals and to convert them to digital data. The output 26 from the surface form determiner may be provided to any suitable resource such as a machining tool or quality control system for feedback control of a process of manufacture and/or it may simply be a wired or wireless network connection and/or a serial or parallel data connection, a USB connection or a connection to a display device.

The functions performed by the surface form determiner 21 which will now be described in more detail with reference to FIG. 2. FIG. 2 shows a functional block diagram of the surface form determiner 21. The surface form determiner 21 comprises surface form model data storage 100, a surface form fitter 112, an angle determiner 104 and data storage 106.

A measured data input 101 of the surface form determiner 21 is coupled to receive data from the interface 22 in FIG. 1. The data input 101 is coupled to the data storage 106. The data storage 106 is itself coupled to the angle determiner 104. A model data input 110 is coupled to the form model data storage 100. The form model data storage 100 is itself coupled to the angle determiner 104 and to the surface form fitter 112. The surface form fitter 112 is coupled to a data output 114. The function of the form model data storage 100 is to store data components of a model of the expected surface form of the work piece 10 in FIG. 1. A model of the surface of an aspheric workpiece may comprise an expression of the form:

$$z = \frac{shape * {x}^{2}}{R + \sqrt{{R}^{2} - ( 1 + k ) * {x}^{2}}} + {\sum }_{i = 1}^{20} {a}_{i} {x}^{i} \qquad ( 1 )$$

where:
x is the radial distance from the optical axis of the component
z is the corresponding vertical distance parallel with the rotation axis;
R is the base radius of the component;
k is the conic constant of the component's surface
shape is a sign parameter of unit magnitude indicating whether the surface is convex or concave; and, the coefficients aᵢ model a deviation of the surface from conic form. The data passed to the model storage 100 from the input 110 may include one or more of the following: estimates of the coefficients aᵢ; an estimate of the base radius, R, of the workpiece; and, an indication of the shape parameter.

The angle determiner 104 performs two functions. Firstly it is configured to determine the traverse tilt angle, β, the angle at which the stylus 28 in FIG. 1 is tilted with respect to the spindle axis 16. Secondly it is configured to determine the axis angle, α, the angle at which the optical axis of a workpiece 10 is tilted with respect to the spindle axis 16.

To determine the traverse tilt, β an optical flat is disposed on the turntable 12. The movement controller 18 in FIG. 1 controls the mover 25 to move the stylus 28 along a measurement path across the surface of the optical flat. The displacement measurer 24 measures the displacement of the stylus tip as it moves along the measurement path. The displacement measurements are communicated to the interface 22 and the measurement data passed from the interface 22 to the input 101 are stored into the data storage 106. The angle determiner 104 then reads the measurement data from the data storage 106 and calculates the tilt angle of the optical flat, τ₀, based on the arctan of the ratio of (1) the displacement in the direction perpendicular to the measurement; to (2) the displacement in the measurement direction. The angle determiner then stores the tilt angle, τ₀, of the optical flat in this orientation into the data storage. The movement controller 18 in FIG. 1 then controls the rotation drive 14 to rotate the turntable 12 through 180°. The measurement of the optical flat is then repeated to determine the tilt angle of the surface of the flat in this new orientation, τ₁₈₀ The angle determiner 104 then retrieves the value of the traverse unit tilt angle, τ₀, of the optical flat in the initial orientation from the data storage 106, and determines the tilt angle, β, of the stylus based on the tilt angle of the optical flat in these two orientations. The tilt angles of the optical flat measured in the two oppositely rotated positions τ₀ and τ₁₈₀ are symmetric about the traverse tilt angle, β of the stylus. Thus the traverse tilt angle, β, is determined by the angle determiner from the bisector angle of τ₀ and τ₁₈₀.

The optical flat is then removed from the turntable 12 and a workpiece 10 to be measured is positioned on the turntable 12 so that, to a first approximation at least, its optical axis coincides with the spindle axis 16 of the turntable 12. The movement controller 18 in FIG. 1 then controls the mover 25 to move the stylus 28 along a measurement path across the surface of the workpiece 10 and the displacement measurer 24 measures the displacement of the stylus tip as it moves along the measurement path. This measurement path provides a profile, r₀, of approximately half of the workpiece. As will be appreciated, an optical flat may comprise an optical-grade component, usually glass, which is flat on one or both sides. Typically an optical flat is flat to an accuracy of 25 nanometres. Other types of flat or reference surface may be used.

The movement controller 18 then controls the rotation drive 14 to rotate the turntable through 180°. The measurement of the half profile of the workpiece is then repeated. The result of this process is that two data sets, r₀ and r₁₈₀ corresponding to the two half profiles obtained from the component in the two different positions. These two half profiles, r₀ and r₁₈₀ are stored in the data storage 106.

To determine the axis tilt angle, α, of the optical axis of the component based on the measured data, r₀ and r₁₈₀, the angle determiner 104 passes the traverse tilt angle value, β, to the surface form fitter 112 and the surface form fitter 112 transforms the measured data, r₀ and r₁₈₀, by applying a coordinate transform to account for the traverse unit tilt angle β. The surface form fitter 112 then retrieves, from the model data storage 100, a priori estimates of: the conic constant of the component's surface, k; the sign parameter indicating whether the surface is convex or concave, shape; the base radius R; and, the coefficients a, of the surface polynomial. These a priori parameter estimates may be based on the design parameters of the component, e.g. the expected characteristics which the component was designed to have.

The surface form fitter then determines a merit function based on the measured data, r₀ and r₁₈₀, and a model of the surface of the component which includes parameters to account for the tilted optical axis (α) and an offset position (x₀, z₀) of the component.

This parameterisation is based on the co-ordinate transform:

$$[ \begin{matrix}\hat{x} \\ \hat{z}\end{matrix} ] = [ \begin{matrix}cs & - sn \\ sn & cs\end{matrix} ] ( [ \begin{matrix}x \\ z\end{matrix} ] - [ \begin{matrix}{x}_{0} \\ {z}_{0}\end{matrix} ] ) \\ where \\ [ \begin{matrix}x \\ z\end{matrix} ] = r , \qquad ( 2 )$$

cs=cos(α), and
sn=sin(α).

Thus,

\hat{x}=cs*(x−x₀)−sn*(z−z₀)

\hat{z}=sn*(x−x₀)+cs*(z−z₀) (3)

In this way, the surface form fitter 112 parameterises the model of equation (1) to provide a merit function and optimises this merit function to estimate a based on a best fit of the half profiles to the model. This optimisation operates by holding the base radius, R, fixed throughout and fitting to determine α, x₀ and z₀. The surface form fitter 112 will now be described in greater detail with reference to FIG. 3.

FIG. 3 shows the surface form fitter 112. The surface form fitter comprises a measured data input 500, a parameter input 502, a model data estimator 504, a difference determiner 506, a Jacobian determiner 508, a linear equation solver 510 and a termination tester 512.

The measured data input 500 is coupled to receive measured data, r₀ and r₁₈₀, and to pass the measured data to the difference determiner 506 and the Jacobian determiner 508. The parameter input 502 is coupled to receive a priori estimates of the model parameters and to pass these to the model data estimator 504. The model data estimator 504 is configured to determine model data values \hat{z} at coordinates \hat{x} according to equation (1) and to pass the model data \hat{z}, \hat{x} to the difference determiner 506 and the Jacobian determiner 508.

The difference determiner 506 is configured to determine the vertical (z direction) difference between the measured points, r₀ and r₁₈₀, and the modelled aspheric profile, thus:

dᵢ=hᵢ−\hat{z}ᵢ (4)
where hᵢ=z(\hat{x}ᵢ)

To determine hᵢ, the difference determiner 506 interpolates between measured points z to obtain an estimate of the measured z value at the modelled x-coordinate \hat{x}. The difference determiner 506 then evaluates the differences, dᵢ between the modelled data \hat{z} and the interpolated measured data hᵢ. The difference determiner 506 passes the determined differences to the linear equation solver 510 and to the Jacobian determiner 508.

The Jacobian determiner 508 determines a Jacobian, J, of the model and measured data according to:

$$\begin{matrix}J = [ \begin{matrix}\frac{\partial {d}_{1}}{\partial α} & \frac{\partial {d}_{1}}{\partial {x}_{0}} & \frac{\partial {d}_{1}}{\partial {z}_{0}} \\ \frac{\partial {d}_{2}}{\partial α} & \frac{\partial {d}_{2}}{\partial {x}_{0}} & \frac{\partial {d}_{2}}{\partial {z}_{0}} \\ ⋮ & ⋮ & ⋮ \\ \frac{\partial {d}_{m}}{\partial α} & \frac{\partial {d}_{m}}{\partial {x}_{0}} & \frac{\partial {d}_{m}}{\partial {z}_{0}}\end{matrix} ] \\ where & ( 5 ) \\ \frac{\partial \hat{z}}{\partial α} = \hat{x} and \frac{\partial \hat{x}}{\partial α} = - \hat{z} & ( 6 ) \\ \frac{\partial {d}_{i}}{\partial α} = \frac{\partial h}{\partial x} \times \frac{\partial \hat{x}}{\partial α} - \frac{\partial \hat{z}}{\partial α} = - ( hd \times \hat{z} + \hat{x} ) & ( 7 ) \\ \frac{\partial {d}_{i}}{\partial {x}_{0}} = \frac{\partial h}{\partial x} \times \frac{\partial \hat{x}}{\partial {x}_{0}} - \frac{\partial \hat{z}}{\partial {x}_{0}} = - ( hd \times cs - sn ) & ( 8 ) \\ \frac{\partial {d}_{i}}{\partial {z}_{0}} = \frac{\partial h}{\partial x} \times \frac{\partial \hat{x}}{\partial {z}_{0}} - \frac{\partial \hat{z}}{\partial {z}_{0}} = hd \times xn + cs & ( 9 )\end{matrix}$$

Where m=the number of measured data points;
cs=cos(α);
sn=sin (α); and
hd=hd(\hat{x})

The Jacobian determiner 508 then passes the Jacobian, J, to the linear equation solver 510 which solves the linear equation:

$${{J}_{m \times 3} [ \begin{matrix}{p}_{α} \\ {p}_{{x}_{0}} \\ {p}_{{z}_{0}}\end{matrix} ]}_{3 \times 1} = - {d}_{m \times 1} \qquad ( 10 )$$

where d=[d₁, d₂, . . . , dₘ]^{T},
to determine a set of perturbations 2 which provide variations in the parameters to be optimised a, x₀, z₀. Such linear equations may be solved by standard methods such as matrix inversion.

The linear equation solver 510 then passes the perturbations p to the termination tester 512. The termination tester 512 applies a threshold test to the perturbation values to determine whether the optimisation has converged.

For each half profile this procedure provides an estimate of α, the axis tilt angle of the component. The first tilt estimate α₁ is the tilt estimated from the first profile r₀, and α₂ is the tilt estimated from the second profile r₁₈₀. For each profile the total tilt β=β+α₁ and γ₂=β−α₂, where the sign change is associated with the rotation of the component on the turntable. This means that the angle(s) derived from the fitting may be used to infer an estimate of the axis tilt angle of the object, α=(γ₁−γ₂)/2. This estimate of the axis tilt angle can be used in the surface model to update the fit of the model to the data.

A termination condition may be based on the condition that the average, γ̅= [symbol] γ₁, γ₂ [symbol] =β. A specific accuracy threshold may be set to test convergence with this condition. Although it is advantageous this termination condition is optional and others may be used, for example based on convergence of the parameter estimates.

In some cases the accuracy threshold may be based on a desired precision requirement, or the accuracy of the calculating apparatus or it may be selected as 0.1% of one or more of the parameter estimates, R, β, γ. Other values may be selected, examples of other values include 0.05%, 0.01% and 0.005% of the respective parameter estimates. In some cases different termination conditions may be applied and/or absolute rather than relative values may be used.

In the event that the termination tester indicates that the solution has converged, the fitted values α, x₀, z₀ are output from the surface form fitter 112. In the event that the termination tester indicates that the termination condition is not met, the perturbations are passed back to the parameter input 502 and the model data estimator 504 updates the model \hat{x}, \hat{z} based on the new parameter estimates, viz:

$$[ \begin{matrix}α \\ {x}_{0} \\ {z}_{0}\end{matrix} ] = [ \begin{matrix}α \\ {x}_{0} \\ {z}_{0}\end{matrix} ] + [ \begin{matrix}{p}_{α} \\ {p}_{{x}_{0}} \\ {p}_{{z}_{0}}\end{matrix} ] \qquad ( 11 )$$

In a second configuration of the surface form fitter 112 it is configured to determine the base radius of the component, 10 in FIG. 1. In this configuration the surface form fitter is configured to treat the determined tilt angle α as a fixed parameter and to optimise the model to determine the best fit base radius, R, in equation 1.

The model data determiner 504 takes the parameters of the model including the a priori estimate of the base radius R and the determined value of the axis tilt angle α and determines the model data \hat{z}, \hat{x} based on these values. The model data \hat{z}, \hat{x} is then passed to the difference determiner 506. As in the first configuration, the difference determiner 506 operates according to equation 4, above and passes the determined difference values to the Jacobian determiner 508.

In this configuration, the Jacobian determiner 508 is configured to determine the Jacobian according to equation 12.

$$J = [ \begin{matrix}1 & \frac{\partial {d}_{1}}{\partial R} \\ 1 & \frac{\partial {d}_{2}}{\partial R} \\ ⋮ & ⋮ \\ 1 & \frac{\partial {d}_{m}}{\partial R}\end{matrix} ] \\ where , \\ \frac{\partial {d}_{i}}{\partial R} = \frac{- shape * {x}^{2}}{( R + \sqrt{{R}^{2} - ( 1 + k ) * {x}^{2}} ) \sqrt{{R}^{2} - ( 1 + k ) * {x}^{2}}} \qquad ( 12 )$$

The Jacobian determiner 508 then passes the Jacobian data values, J, to the linear equation solver 510 which solves the linear equation

$${J}_{m \times 2} [ \begin{matrix}{p}_{D C} \\ {p}_{R}\end{matrix} ] = - {d}_{m \times 1} where d = {[ {d}_{1} , {d}_{2} , … , {d}_{m} ]}^{T} \qquad ( 13 )$$

to determine the perturbations p. Such linear equations may be solved by standard methods such as matrix inversion.

The linear equation solver 510 then passes the perturbations 2 to the termination tester 512. The termination tester 512 applies a threshold test to the perturbation values to determine whether the optimisation has converged, the termination condition to be a correction of less than 0.1% of the respective parameter values.

In the event that the termination tester 512 indicates that the solution has converged, the fitted base radius value R is output from the surface form fitter 112. In the event that the termination tester indicates that the termination condition is not met, the perturbations are passed back to the parameter input 502 and the model data estimator 504 updates the model \hat{x}, \hat{z} based on the new parameter estimates, viz:

$$[ \begin{matrix}{z}_{0} \\ R\end{matrix} ] = [ \begin{matrix}{z}_{0} \\ R\end{matrix} ] + [ \begin{matrix}{p}_{D C} \\ {p}_{R}\end{matrix} ] \qquad ( 14 )$$

Although the termination condition is selected as 0.1% of the respective parameter estimates other values may be selected, examples of other values include 0.05%, 0.01% and 0.005% of the respective parameter estimates. In some cases different termination conditions may be applied to the different parameters and/or absolute rather than relative values may be used. For example, where the estimate of radius, R, is updated, it may be used to determine tilt angles γ₁ and γ₂ of the two profiles and, the termination condition may be provided by testing that the average of γ₁ and γ₂ is equal to the traverse unit tilt angle, β. A selected accuracy threshold may be used for this equality.

The base radius R may also be determined by a search technique. The estimate of the axis tilt angle, α, for each half profile depends upon the estimate of the base radius.

If the estimate of the tilt angle, α, for the first half profile, r₀, is referred to as α₁ and the estimate of the tilt angle for the first half profile, r₁₈₀, is referred to as α₂, two angles may be defined γ₁=β+α₁ and γ₂=β−α₂. The inventors in the present case have appreciated that, where an accurate estimate of the radius is used to determine the tilt angles γ₁ and γ₂, the mean tilt angle γ̅ is equal to the calibrated traverse unit tilt angle β. In addition, the angles γ₁, γ₂, derived from the fitting may be used to infer an estimate of the axis tilt angle of the object, α=(γ=γ₁−γ₂)/2. This estimate of the axis tilt angle can be used in the surface model to update the fit of the model to the data.

FIG. 4 shows a form determiner which may be used as the optional validation module 109 in FIG. 2, or as a replacement for the surface form fitter in the example of FIG. 2. Where the surface form fitter 112 is replaced by the form determiner of FIG. 4, the surface form fitter 112 may be used as the optional validation module 109. The form determiner 109 has a surface form calculator 602 and a termination tester 604. The surface form fitter 602 is configured to receive inputs comprising β, the measured traverse unit tilt angle, the parameters of the model in equation 1, the measured data defining the two half profiles, r₀ and r₁₈₀, and a starting estimate of the base radius R.

For each half profile an angle, γ may be defined which is the sum of the traverse unit tilt angle β and the axis tilt angle α fitted for that half profile. This is illustrated in FIG. 5. The angle γ depends upon the radius, R, used in the surface form model defined in equation 1. The form of this dependence is plotted out in FIG. 6. As shown in FIG. 6, at the true base radius the average value of γ, from the two half profiles will be β. In other words, given a correct estimate of radius, R, the traverse unit tilt angle bisects the angle γ associated with fitting the two half profiles using this (correct) estimate of radius.

The surface form fitter 602 is configured to determine γ₁ and γ₂ using the starting estimate of base radius and to pass the determined values to the termination tester 604. The termination tester 604 evaluates the test value,

$$t = \frac{{γ}_{1} + {γ}_{2}}{2} - β .$$

In the event that the test value, t, is greater than a selected accuracy threshold, for example less than 0.005°, the termination tester 604 updates the estimate of the base radius, R and triggers the surface form fitter to calculate new estimates of γ₁ and γ₂ based on the updated estimate of R. In the event that the test value, t, is less than the selected accuracy threshold then the termination tester triggers the end of the iterative search and the estimate of radius R and the value of α is calculated based on the angles γ and output from the determiner 109.

The search algorithm described above with reference to FIG. 4 may be performed in accordance with a variety of known methods such as the Newton algorithm, or the Gauss-Newton algorithm. Other search algorithms may also be used.

The values of axis tilt angle α and base radius R determined using the form determiner 109 of FIG. 4 may be used in combination with the system described above with reference to FIGS. 2 and 3. For example estimates from the form determiner of FIG. 4 may be used as inputs (e.g. a priori parameter estimates) to the system of FIG. 2 and FIG. 3. As another example, the values of axis tilt angle α and base radius R determined using the system of FIG. 2 and FIG. 3 may be provided as inputs (e.g. a priori parameter estimates) to the system of FIG. 4. Other combinations of the two approaches may also be used, for example one of the two processes may be used to verify the results of the other.

In the examples and embodiments described above, the data processors of FIG. 2, FIG. 3 and FIG. 4 are implemented by a computing apparatus, such as a suitably programmed general purpose computer. It will, of course, be understood that one or more computing apparatus may be used and that such computing apparatus may or may not be physically separated. In addition, it may be possible to implement the described examples and embodiments by use of hard-wired circuitry and one or more digital signal processors (DSPs), for example. The functionality need not necessarily be provided by one physical entity (for example computing apparatus). As an example, the measurement data provided by the displacement measurer 24 in FIG. 1 may be measured by an apparatus in one location and the measured data may be transmitted (e.g. over a network) to a second location for processing. The calibration step, in which the traverse unit tilt angle is determined may be performed separately and, once known, the same traverse unit tilt angle may be used for all experiments with a single machine. In some cases the traverse unit tilt angle will be known in advance and so need not be calibrated/determined at all.

Different parts of the functionality of the systems described above with reference to FIG. 1, FIG. 2, FIG. 3 and FIG. 4 may be provided by physically separate entities which may be located at the same or different locations. Separate physical entities may be connected by a wireless or wired link or via a network such as the Internet, an intranet, a WAN or LAN, for example. It should also be appreciated that the modules and functional blocks are shown in the Figures for the purposes of illustration and do not necessarily imply that the functionality is so divided. Thus, it should be understood that the functional block diagrams are intended simply to show the functionality that exists and should not be taken to imply that each block shown in the functional block diagram is necessarily a discrete or separate entity. The functionality provided by a block may be discrete or may be dispersed throughout the apparatus or throughout a part of the apparatus. In addition, the functionality may incorporate, where appropriate, hard-wired elements, software elements or firmware elements or any combination of these.

The present invention also provides a computer program product to program in the apparatus to provide the data processor 21 shown in FIG. 1, or the system of FIG. 2, FIG. 3 or FIG. 4 and/or to provide any other functionality of the system described above. As shown in FIG. 7 the movement controller 18 and the data processor 21 and interface 22 of the surface form measurer 1 shown in FIG. 1 may be provided by a suitably programmed general purpose computer 810. In this case the computer 810 is programmed by a computer program product 800 carrying program instructions operable to program a programmable processor to provide the functionality of the data processor 21 and/or to perform one or more of the methods described above with reference to FIGS. 1 to 4. The computer program product 800 may be carried on a computer readable storage medium such as a CD-ROM, DVD, FLASH memory storage or in other volatile or non volatile memory storage. In some cases the computer program product may be transmitted to the computer 800 over a network, for example as a download e.g. in response to an FTP or HTTP request.

Non Limiting Illustrative Examples

To illustrate the foregoing there now follow a number of non-limiting examples. The following disclosure should in no way be considered to limit the description, statements of invention and claims provided elsewhere herein. To the extent that the following examples imply that any feature is essential this is only a statement that those features are relevant to the particular example being described.

### Half Aspheric Profile Data Fusion and Analysis

This document described the technique for data fusion and analysis of half profile aspherical measurements.

Why we Need the Half Aspheric Analysis?

To evaluate the aspheric form error, the aspheric component was centred and leveled, and a number of diagonal profiles will be measured across the assumed aspheric axis. The key problem for this method is that the contact angle between the styli and the curved aspheric surface swings from positive to negative angle. As the radius of the aspheric part gets smaller, the contact angle at the both ends gets larger, such as 60 and 70 degree. That is way off the recommend contact angle of less than 35 degree for the stylus instrument. On the other hand, the negative contact angle on the downhill measurement is prone to the flick error. In order to reduce the contact angle, we can tilt the traverse unit to the half position in the horizontal measurement, and then measuring half aspheric profiles. A problem addressed by the present disclosure is how to align those half profiles accurately.

What is the Main Problem?

The spherical and aspheric component can be simulated by rotating a half spherical or aspheric profile along the vertical axis. An aspheric surface is generated from a surface that has a basic conic section onto which a symmetrical polynomial deviation is superimposed. This surface can be described by an expression in the explicit form, as follows:

$$z = \frac{shape * {x}^{2}}{R + \sqrt{{R}^{2} - ( 1 + k ) * {x}^{2}}} + {\sum }_{i = 1}^{20} {a}_{i} {x}^{i} \qquad ( 1 )$$

where: x is the radial distance from the aspheric rotation axis and z is the corresponding vertical distance parallel with the rotation axis;
   R is the base radius of surface;
   k is the conic constant.
   shape is the sign of convex or concave.
   the remaining terms describe the symmetrical polynomial deviation from the basic conic form.

By taking a diametrical profile across the centre, the profile will be displayed symmetrically about the rotation axis Y as shown in FIG. 8. To evaluate the aspheric form error and residual, we need to best fit the measured profiles with the designed aspherical coefficients. Two types of fitting parameters should be obtained, that is
the position parameters of aspheric: the aspheric center position (x₀, z₀) and the aspherical axis tilt angle α
the dimensional parameter: the aspheric radius R

For a full profile measurement, the positional parameters are determined by the profile symmetrical form along its axis, and so are decoupled from its dimensional radius R. However, for half profiles, this decoupling affect is relaxed, and so the positional parameters and dimensional parameter are compound through the real form error of the aspheric part. Due to the non-linearity of the aspherical fitting, there is no easy way to theoretically separate this binding, and so the fitted positional parameters and dimensional parameter will affect each other within a certain range. For the simulated profile with no form error, there is no cross effect between them.

In simple terms, the aspheric axis and radial dimensions are difficult to obtain at the same time from the half profile measurements. The positional parameters and radial dimensional parameter obtained from the least square best fitting will give a close approximation, and the solution will be varied with the initial settings for the fitting and the real aspherical form error. It has been observed from the practical experimental data, that the fitted radius could vary within a couple of μm with a slightly different initial axis position. From the above analysis, one way to find the accurate positional parameters and dimensional parameter is to separately evaluate them from the half profile measurements.

We proposed to evaluate the axis of the aspheric first and then to evaluate the aspheric radius second. The true angles of the paired half profiles are compose of two parts as the traverse unit tilt angle and the optical axis tilt in refer to the spindle axis, which is symmetrical about the traverse unit angle for 180 degree half profiles as shown in FIG. 9.

The traverse unit tilt angle is fixed during the measurement and can be obtained by measuring an optical flat. Similar to the aspherical component we are trying to evaluate, an optical flat has the similar sine wave of the axis angle vs the table rotation. Because there is no dimensional parameter for the optical flat, so the tilt angles of paired straight lines in 180 degree apart will be symmetrical about the traverse unit tilt angle β. The calibration precision of 0.001 degree can be easily achieved.

For the half aspheric profiles, the best fitted radius \tilde{R} from the measured half profile data is not guaranteed to be the true radius because the mean tilt angle γ̅ of γ₁ and γ₂ at this radius is not surely equal to the calibrated traverse unit tilt angle. However, they are normally a close approximation of the true value.

As mentioned above because the cross affect of the positional and dimensional parameters, both the tilt angles γ₁ and γ₂ of the half profiles as well as the mean tilt angle γ̅ will vary with the different fitting radius. So for a single half profile, we can only estimate the true radius and axis tilt angle within a certain range, which is normally with uncertainty of a couple of um in radius and tenth of fraction degree in tilt angle.

However, for paired half profile measurements of similar length and symmetrical form and form error in the opposite direction, their tilt angles γ, and γ₂ will change in the similar rate and along the same direction as shown in FIG. 6. The shapes of the tilt angle curves are determined by the practical noise profile data. For the simulated noise free data, the tilt angles γ, and γ₂ will be a constant.

The reason behind it is that even the best-fit tilt angle is a different non-linear model for each half profile, it can be approximated by a same and simple linear model within a small range of radius, of which the initial best fit can give a effective start point. That is, the opening angle of 2α of the paired half profiles is constant within the small radius range.

The true radius \hat{R} will be refer to the position when the mean tilt angle γ̅ of γ₁ and γ₂ is equal to the calibrated traverse unit tilt angle β. So a method can be developed to find this radius by trying and searching over a range of radius, and so obtain both the positional and dimensional fitting parameters. However, this method will be very time consume and with compromise of the accuracy.

The proposed method at here is first to find the accurate axial angle and then to estimate the dimensional radius separately. Because even they are cross effect each other, but the results will be no difference if we fix radius to find the true axial angle, and vice versa.

Using the knowledge of the constant tilt angle difference between γ₁ and γ₂, the true tilt angles γ₁ and γ₂ at the true radius \hat{R} will be symmetrical about the traverse tilt angle β. After we get the very accurate positional parameter eg. the axial angle for both the half profiles. The true radius \hat{R} can be estimated by the least square fitting with the fixed and known axial angle.

With both the positional and dimensional parameters accurately estimated, the half profiles can be analysed separately or fused into a full profile. With a number of paired half or full profiles along different directions, a complete surface can be obtained by stitching them. The above proposed method can be achieve 10 s nm accuracy on the aspherical form error for up to 70 degree steep aspherical component, which is compatible with the current limit of the uCMM.

Examples of Fitting Procedures

There are several methods that can be used to classify surface fitting techniques. A common method is to classify them into linear Least Squares (LS) and non-linear Least Squares (NLS) fitting on the basis of the linearity of the optimization parameters. However, here a more intuitive way and classify the surface fitting, is taken, according to the form of surface equations, i.e.
Implicit form: ƒ(x, y, z)=0
Explicit form: z=ƒ(x, y)
Parameterizing form: x=r cos(θ)
   y=r sin(θ) for a circle

TABLE 1

| Surface type | Normalized form |
|---|---|
| Ellipsoid | $\frac{{x}^{2}}{{a}^{2}} + \frac{{y}^{2}}{{b}^{2}} + \frac{{z}^{2}}{{c}^{2}} = 1$ |
| spheroid (special case of ellipsoid) | $\frac{{x}^{2}}{{a}^{2}} + \frac{{y}^{2}}{{a}^{2}} + \frac{{z}^{2}}{{b}^{2}} = 1$ |
| sphere (special case of spheroid) | $\frac{{x}^{2}}{{a}^{2}} + \frac{{y}^{2}}{{a}^{2}} + \frac{{z}^{2}}{{a}^{2}} = 1$ |
| Elliptic paraboloid | $\frac{{x}^{2}}{{a}^{2}} + \frac{{y}^{2}}{{b}^{2}} - z = 0$ |
| Circular paraboloid | $\frac{{x}^{2}}{{a}^{2}} + \frac{{y}^{2}}{{a}^{2}} - z = 0$ |
| Hyperbolic paraboloid | $\frac{{x}^{2}}{{a}^{2}} - \frac{{y}^{2}}{{b}^{2}} - z = 0$ |
| Hyperboloid of one sheet | $\frac{{x}^{2}}{{a}^{2}} + \frac{{y}^{2}}{{b}^{2}} - \frac{{z}^{2}}{{c}^{2}} = 1$ |
| Hyperboloid of two sheets | $\frac{{x}^{2}}{{a}^{2}} + \frac{{y}^{2}}{{b}^{2}} - \frac{{z}^{2}}{{c}^{2}} = - 1$ |
| cone | $\frac{{x}^{2}}{{a}^{2}} + \frac{{y}^{2}}{{b}^{2}} - \frac{{z}^{2}}{{c}^{2}} = 0$ |
| Elliptic cylinder | $\frac{{x}^{2}}{{a}^{2}} + \frac{{y}^{2}}{{b}^{2}} = 1$ |
| Hyperbolic cylinder | $\frac{{x}^{2}}{{a}^{2}} - \frac{{y}^{2}}{{b}^{2}} = 1$ |
| Parabolic cylinder | x² + 2ay = 0 |

In general, an explicit form is the desired format due to the fact that both algebraic and geometry distance fitting can be easily implemented. On the other hand, the implicit form, especially for the quadric surface fitting, could be used as the initial estimation of a final non-linear least squares (LS) approximation.

Types of Quadric Surfaces

The normalized equation for a three-dimensional quadric surface centred at the origin (0,0,0) is:

$$\pm \frac{{x}^{2}}{{a}^{2}} \pm \frac{{y}^{2}}{{b}^{2}} \pm \frac{{z}^{2}}{{c}^{2}} = 1 \qquad ( 1 )$$

Via translations and rotations every quadric can be transformed to one of several “normalized” forms. In three-dimensional Euclidean space there are 17 such normalized forms, and the most interesting, the non-degenerate forms are given in Table 1. The remaining forms are called degenerate forms and include planes, lines, points or even no points at all.

Aspheric Profile Fitting

An aspheric profile is generated from a profile that has a basic conic section onto which a symmetrical polynomial deviation is superimposed. This profile can be described by an expression in the explicit form, as follows:

$$z = \frac{shape * {x}^{2}}{R + \sqrt{{R}^{2} - ( 1 + k ) * {x}^{2}}} + {\sum }_{i = 1}^{20} {a}_{i} {x}^{i} \qquad ( 2 )$$

where: r is the radial distance from the aspheric rotation axis and z is the corresponding vertical distance parallel with the rotation axis;
   R is the base radius of surface;
   shape is the sign of convex or concave.
   k is the conic constant. The term ‘conic’ comes from the sections that can be derived by slicing a cone at various positions, and there are four different types of curves depending on the position of the cutting plane relative to the cone;
   the remaining terms (aᵢ) describe the symmetrical polynomial deviation from the basic conic form.

Non-Linear Least Squares

It is straightforward and stable to obtain the least squares best-fit solution for equation (2). The solution is to minimize the following function:

$$F = {\sum }_{i = 1}^{m} {( {z}_{i} - f ( {x}_{i} , {y}_{i} ) )}^{2} \qquad ( 3 )$$

with equation (2) is in the form of z=ƒ (x, y)

However, the above problem is a non-linear least squares one, and methods for solving it need formulas for the derivatives of F: Provided that f has continuous second partial derivatives, we can write its Taylor expansion as

ƒ(a+p)=ƒ(a)+J(a)p+O(∥p∥²) (4)
where a=[a₁, a₂, . . . , aₙ]^{T} is the optimisation parameters, JεR^{m×n} the Jacobian. This is a matrix containing the first partial derivatives of the function components,

$${( J ( a ) )}_{ij} = \frac{\partial {f}_{i}}{\partial {a}_{j}} ( a ) \qquad ( 5 )$$

As regards F: Rⁿ [symbol] R, it follows from the first formulation in equation (3), that

$$\frac{\partial F}{\partial {a}_{j}} ( a ) = {\sum }_{i = 1}^{m} {f}_{i} ( a ) \frac{\partial {f}_{i}}{\partial {a}_{j}} ( a ) \qquad ( 6 )$$

Thus, the gradient is

g(a)=F′(a)=J(a)^{T}ƒ(a) (7)

For minimization of a function of several variables a, let g(a) be the gradient of F, gⱼ=δFaⱼ, and H the Hessian matrix of second partial derivatives,

$$\begin{matrix}{H}_{jk} = \frac{{\partial }^{2} F}{\partial {a}_{j} \partial {a}_{k}} \\ = {\sum }_{i = 1}^{m} ( \frac{\partial {f}_{i}}{\partial {a}_{j}} ( a ) \frac{\partial {f}_{i}}{\partial {a}_{k}} ( a ) + {f}_{i} ( a ) \frac{{\partial }^{2} {f}_{i}}{\partial {a}_{j} \partial {a}_{k}} ( a ) ) \\ = {J}^{T} J + {\sum }_{i = 1}^{m} {f}_{i} ( a ) {f}_{i}^{″} ( a )\end{matrix} \qquad ( 8 )$$

At a local minimum a* of F, g(a*)=0. If a is an approximate solution we wish to find a step p such that g(a+p)=0. To first order,

g(a+p)=g(a)+Hp (9)

suggesting that p should be chosen so that

Hp=−g (10)

Newton Algorithm

In the Newton algorithm, an estimate of the solution a is updated according to a:=a+tpₙₜ, where pₙₜ solves Hpₙₜ=−g and t is a step length chosen to ensure a sufficient decrease in F. Near the solution, the Newton algorithm converges quadratically, i.e., if at the kth iteration the distance of the current estimate aₖ of the solution a* is ∥aₖ−a*∥ then the distance of the subsequent estimate aₖ₊₁ from the solution is ∥aₖ₊₁−=a*∥=O(∥aₖ−a∥²) so that the distance to the solution squares approximately at iteration.

Gauss-Newton Algorithm

The Gauss-Newton algorithm is a modification of Newton's algorithm for minimizing a function. It is based on a linear approximation to the components of f (a linear model of f) in the neighbourhood of a: For small ∥p∥ we see from the Taylor expansion that

ƒ(a+p)□ƒ(a)+J(a)p_{gn} (11)

With the Jacobian matrix J, then g=J^{T} ƒ and H=J^{T} J+G, where

$${G}_{jk} = {\sum }_{i = 1}^{m} {f}_{i} \frac{{\partial }^{2} {f}_{i}}{\partial {a}_{j} \partial {a}_{k}} \qquad ( 12 )$$

So, in the Gauss-Newton (GN) algorithm follows, H is approximated by J^{T} J, i.e, the term G is ignored and p_{gn} is found by solving the linear least squares problem J^{T} Jp=−J^{T} ƒ. This is a linear least squares problem and can be solved using an orthogonal factorization approach. The typical step is
Solve (J^{T} J)p_{gn}=−J^{T} ƒ

a:=a+tp_{gn} (13)
where t is found by line search. The classical Gauss-Newton method uses t=1 in all steps.

The Gauss-Newton algorithm in general converges linearly at a rate that depends on the condition of the approximation problem, the size of the residuals f near the solution and the curvature. If the problem is well-conditioned, the residuals are small and the summand functions ƒᵢ are nearly linear, then J^{T} J is a good approximation to the Hessian matrix H and convergence is fast.

Aspheric Profile Fitting—Positional Parameters Fitting

For the aspheric profile, the positional parameters include the axis tilt angle (α) and the central position (x₀, z₀), and the coordinate transform can be written as:

$$[ \begin{matrix}\hat{x} \\ \hat{z}\end{matrix} ] = [ \begin{matrix}cs & - sn \\ sn & cs\end{matrix} ] ( [ \begin{matrix}x \\ z\end{matrix} ] - [ \begin{matrix}{x}_{0} \\ {z}_{0}\end{matrix} ] ) \qquad ( 14 )$$

where cs=cos(α) and sn=sin(α). So we can get the new roto-translated coordinates as:

\hat{x}=cs*(x−x₀)−sn*(z−z₀)

\hat{z}=sn*(x−x₀)+cs*(z−z₀) (15)

If the nominal function for the aspheric profile is as

$$\begin{matrix}z = \frac{shape * {cx}^{2}}{1 + \sqrt{1 - ( 1 + k ) {c}^{2} {x}^{2}}} + {\sum }_{i = 1}^{20} {a}_{n} {x}^{n} \\ = \frac{shape * {x}^{2}}{R + \sqrt{{R}^{2} - ( 1 + k ) {x}^{2}}} + {\sum }_{i = 1}^{20} {a}_{n} {x}^{n} \\ = \frac{shape * ( R - \sqrt{{R}^{2} - ( 1 + k ) {x}^{2}} )}{1 + k} + {\sum }_{i = 1}^{20} {a}_{n} {x}^{n}\end{matrix} \qquad ( 16 )$$

where shape=1 corresponding to convex and −1 for concave aspheric curve.

The slope of the curve could be obtained as

$$\begin{matrix}\frac{\partial z}{\partial x} = \frac{shape * ( 1 + k ) * 2 x}{2 ( 1 + k ) \sqrt{{R}^{2} - ( 1 + k ) {x}^{2}}} + {\sum }_{i = 1}^{20} {na}_{n} {x}^{n - 1} \\ = \frac{shape * x}{\sqrt{{R}^{2} - ( 1 + k ) {x}^{2}}} + {\sum }_{i = 1}^{20} {na}_{n} {x}^{n - 1} \\ = hd\end{matrix} \qquad ( 17 )$$

The distance from the measured point to the aspheric profile is defined as

dᵢ=hᵢ−\hat{z}ᵢ (18)
where hᵢ=z(\hat{x}ᵢ)

Three parameters (α, x₀, z₀) needed to be solved for the best-fitting. Based on equation (18), the Jacobian matrix is

$$\begin{matrix}J = [ \begin{matrix}\frac{\partial {d}_{1}}{\partial α} & \frac{\partial {d}_{1}}{\partial {x}_{0}} & \frac{\partial {d}_{1}}{\partial {z}_{0}} \\ \frac{\partial {d}_{2}}{\partial α} & \frac{\partial {d}_{2}}{\partial {x}_{0}} & \frac{\partial {d}_{2}}{\partial {z}_{0}} \\ ⋮ & ⋮ & ⋮ \\ \frac{\partial {d}_{m}}{\partial α} & \frac{\partial {d}_{m}}{\partial {x}_{0}} & \frac{\partial {d}_{m}}{\partial {z}_{0}}\end{matrix} ] \\ with & \\ \frac{\partial \hat{z}}{\partial α} = \hat{x} \\ and \\ \frac{\partial \hat{x}}{\partial α} = \hat{z} & ( 19 ) \\ \begin{matrix}\frac{\partial {d}_{i}}{\partial α} = \frac{\partial h}{\partial \hat{x}} \times \frac{\partial \hat{x}}{\partial α} - \frac{\partial \hat{z}}{\partial α} \\ = - ( hd \times \hat{z} + \hat{x} )\end{matrix} & ( 20 ) \\ \begin{matrix}\frac{\partial {d}_{i}}{\partial {x}_{0}} = \frac{\partial h}{\partial \hat{x}} \times \frac{\partial \hat{x}}{\partial {x}_{0}} - \frac{\partial \hat{z}}{\partial {x}_{0}} \\ = - ( hd \times cs - sn )\end{matrix} & ( 21 ) \\ \begin{matrix}\frac{\partial {d}_{i}}{\partial {z}_{0}} = \frac{\partial h}{\partial \hat{x}} \times \frac{\partial \hat{x}}{\partial {z}_{0}} - \frac{\partial \hat{z}}{\partial {z}_{0}} \\ = hd \times sn + cs\end{matrix} & ( 22 )\end{matrix}$$

where hd=hd(\hat{x}) the new height value after roto-translation of x.

The solution will be the results of the linear least squares system

$${{J}_{m \times 3} [ \begin{matrix}{p}_{α} \\ {p}_{{x}_{0}} \\ {p}_{{z}_{0}}\end{matrix} ]}_{3 \times 1} = - {d}_{m \times 1} \\ where \\ d = {[ {d}_{1} , {d}_{2} , … , {d}_{m} ]}^{T } \qquad ( 23 )$$

Update the parameter estimates according to

$$[ \begin{matrix}α \\ {x}_{0} \\ {z}_{0}\end{matrix} ] = [ \begin{matrix}α \\ {x}_{0} \\ {z}_{0}\end{matrix} ] + [ \begin{matrix}{p}_{α} \\ {p}_{{x}_{0}} \\ {p}_{{z}_{0}}\end{matrix} ] \qquad ( 24 )$$

And then iterate the above fitting until it satisfies the termination conditions.

Dimensional Parameters Fitting

For the aspheric profile, the dimensional parameter includes only the radius. In order to decouple the cross affects between the positional and dimensional parameters, the DC level may be used as a dummy parameter in the radius optimisation. Similarly to the positional parameter fitting, the Jacobian matrix for fitting the aspheric radius R is:

$$J = [ \begin{matrix}1 & \frac{\partial {d}_{1}}{\partial R} \\ 1 & \frac{\partial {d}_{2 }}{\partial R} \\ ⋮ & ⋮ \\ 1 & \frac{\partial {d}_{m}}{\partial R}\end{matrix} ] \\ with \\ \frac{\partial {d}_{i}}{\partial R} = \frac{- shape * {x}^{2}}{( R + \sqrt{{R}^{2} - ( 1 + k ) * {x}^{2}} ) \sqrt{{R}^{2} - ( 1 + k ) * {x}^{2}}} \qquad ( 25 )$$

The solution will be the results of the linear least squares system

$${J}_{m \times 2} [ \begin{matrix}{p}_{DC} \\ {p}_{R}\end{matrix} ] = - {d}_{m \times 1} \\ where \\ d = {[ {d}_{1} , {d}_{2} , … , {d}_{m} ]}^{T} \qquad ( 26 )$$

Update the parameter estimates according to

$$[ \begin{matrix}{z}_{0} \\ R\end{matrix} ] = [ \begin{matrix}{z}_{0} \\ R\end{matrix} ] + [ \begin{matrix}{p}_{DC} \\ {p}_{R}\end{matrix} ] \qquad ( 27 )$$

And then iterate the above fitting until it satisfies the termination conditions.

Accordingly the roto-translation matrix can enable both initial and final fitting of surfaces to their equations even through they make calculations of Jacobian matrix in the fitting processing much more complicated.

1. A computer implemented method of determining the surface shape of an aspheric object using a metrological apparatus, the method comprising:
positioning the object on a support surface of a turntable of the metrological apparatus so that an axis of the object is tilted with respect to the axis of rotation of the turntable by a tilt angle, α;
using a measurement probe to make a first measurement of the object to provide first measurement data; rotating the turntable;
after rotation of the turntable, using a measurement probe to make a second measurement of the object, diametrically opposite the first measurement, to provide second measurement data,
estimating a first angle, γ₁, based on fitting the first measurement data using a surface model comprising:
a dependency on the axis tilt angle, α, and
a dependency on the radius, R, of the base of the object;
estimating a second angle, γ₂, based on fitting the second measurement data to the surface model; and
determining the axis tilt angle based on the first angle and the second angle.

2. The method of claim 1 in which determining the axis tilt angle based on the first angle and the second angle comprises determining the axis tilt angle based on the difference between the first angle and the second angle.

3. The method of claim 1 in which estimating the first angle comprises estimating the radius, R, of the base of the object, and optimising the estimate of the radius by fitting the surface model to the first measurement data, and determining the first angle based on the surface model and the optimised estimate of the radius.

4. The method of claim 1, in which estimating the second angle comprises estimating the radius, R, of the base of the object, and optimising the estimate of the radius by fitting the surface model to the second measurement data, and determining the second angle based on the surface model and the optimised estimate of the radius.

5. The method of claim 1 in which fitting the first or second measurement data comprises using a fixed estimate of the axis tilt angle, α, whilst varying the estimate of radius R to optimise the fit of the surface model to said measurement data.

6. The method of claim 1 in which estimating the first angle comprises estimating the axis tilt angle, α, and optimising the estimate of the axis tilt angle based on fitting the surface model to the first measurement data, and determining the first angle based on the surface model and the optimised estimate of the axis tilt angle, α.

7. (canceled)

8. The method of claim 6 comprising estimating the aspheric center position, x₀, z₀, and using the estimated aspheric center position in optimising the estimate of the axis tilt angle.

9. (canceled)

10. The method of claim 1 in which fitting the first measurement data and/or second measurement data comprises treating the radius, R, as constant and fitting to determine the axis tilt angle.

11. (canceled)

12. (canceled)

13. The method of claim 1 in which the measurement probe of the metrological apparatus is aligned with the axis of rotation of the turntable.

14. The method of claim 1 in which the measurement probe of the metrological apparatus is tilted with respect to the axis of rotation of the turntable by an angle less than 70 °.

15. (canceled)

16. (canceled)

17. The method of claim 1 in which the surface model comprises
$$z = \frac{shape * {x}^{2}}{R + \sqrt{{R}^{2} - ( 1 + k ) * {x}^{2}}} + {\sum }_{i = 1}^{20} {α}_{i} {x}^{i} \qquad ( 1 )$$
where:
x is the radial distance from the axis of the aspheric object;
z is the corresponding vertical distance parallel with the rotation axis;
R is the base radius of the object;
k is the conic constant of the object surface;
shape is a sign parameter indicating whether the surface is convex or concave; and the coefficients α, describe the polynomial function.

18. (canceled)

19. The method of claim 1 comprising determining the tilt angle based on a measurement of a reference surface based on: using a measurement probe to make a first measurement of the reference surface to provide first reference measurement data;
rotating the turntable;
after rotation of the turntable, using a measurement probe to make a second measurement of the object to provide second reference measurement data;
and determining the tilt angle of the measurement probe based on the first and second measurement data.

20. (canceled)

21. The method of claim 1 comprising determining an average of the first angle and the second angle and, in the event that the average is equal to a tilt angle of the measurement probe, determining the axis tilt angle based on the tilt angle of the probe and at least one of the first angle and the second angle.

22. The method of claim 1 comprising repeating the estimation of the first angle and the second angle based on the determined tilt angle, and in which estimating the first angle and estimating the second angle comprises updating an estimate of the radius, R, of the base of the object.

23. (canceled)

24. A metrological apparatus for determining the surface shape of an aspheric object, the apparatus comprising;
a turntable having a support surface for supporting an object to be measured, wherein the turntable is operable to rotate about a rotation axis;
a measurement probe operable to traverse a measurement path across the surface of the object to be measured to provide measurement data;
a controller operable to control the measurement probe to traverse a first measurement path to provide first measurement data and to rotate the turntable and, after rotation of the turntable, to control the measurement probe to traverse a second measurement path to provide second measurement data, wherein the first measurement path and the second measurement path are diametrically opposite each other on the surface of the object,
and a data processor configured to:
estimate a first angle, γ₁, based on fitting the first measurement data using a surface model comprising: a dependency on the axis tilt angle, α, and a dependency on the radius, R, of the base of the object;
estimate a second angle, γ₂, based on fitting the second measurement data to the surface model; and to
determine the axis tilt angle based on at least one of the first angle and the second angle.

25. The metrological instrument of claim 24 in which the data processor is configured to perform the method comprising the steps of:
positioning the object on a su ort surface of a turntable of the metrological apparatus so that an axis of the object is tilted with respect to the axis of rotation of the turntable by a tilt angle, α;
using a measurement probe to make a first measurement of the object to provide first measurement data; rotating the turntable;
after rotation of the turntable, using a measurement probe to make a second measurement of the object, diametrically opposite the first measurement, to provide second measurement data,
estimating a first angle, γ₁, based on fitting the first measurement data using a surface model comprising:
a dependency on the axis tilt angle, α, and
a dependency on the radius, R, of the base of the object;,
estimating a second angle, γ₂, based on fitting the second measurement data to the surface model; and
determining the axis tilt angle based on a difference between the first angle and the second angle.

26. A data processor for a metrological instrument, wherein the processor is configured to:
receive first measurement data and second measurement data, wherein the first and second measurement data each provide a part of a measurement of the profile of the surface of an aspheric object to be measured;
estimate a first angle, γ₁, based on fitting the first measurement data using a surface model comprising: a dependency on the axis tilt angle, α, and a dependency on the radius, R, of the base of the object;
estimate a second angle, γ₂, based on fitting the second measurement data to the surface model; and to
determine the axis tilt angle based on the tilt angle of the probe and at least one of the first angle and the second angle.

27. The data processor of claim 26 configured to perform a method comprising the steps of:
positioning the object on a support surface of a turntable of the metrological apparatus so that an axis of the object is tilted with respect to the axis of rotation of the turntable by a tilt angle, α;
using a measurement probe to make a first measurement of the object to provide first measurement data; rotating the turntable;
after rotation of the turntable, using a measurement probe to make a second measurement of the object, diametrically opposite the first measurement, to provide second measurement data,
estimating a first angle, γ₁, based on fitting the first measurement data using a surface model comprising:
a dependency on the axis tilt angle, α, and
a dependency on the radius, R, of the base of the object;
estimating a second angle, γ₂, based on fitting the second measurement data to the surface model; and
determining the axis tilt angle based on a difference between the first angle and the second angle.

28. The data processor of claim 26 in which the processor is configured to determine an average of the first angle and the second angle and to update the estimate of the axis tilt angle to be used in the surface model in the event that the average is not equal to the tilt angle of the measurement probe.

29. (canceled)

30. A non-transitory computer readable medium storing program instructions operable to program a processor to perform a method comprising the steps of:
positioning the object on a support surface of a turntable of the metrological apparatus so that an axis of the object is tilted with respect to the axis of rotation of the turntable by a tilt angle, α;
using a measurement probe to make a first measurement of the object to provide first measurement data; rotating the turntable;
after rotation of the turntable, using a measurement probe to make a second measurement of the object, diametrically opposite the first measurement, to provide second measurement data,
estimating a first angle, γ₁, based on fitting the first measurement data using a surface model comprising:
a dependency on the axis tilt angle, α, and
a dependency on the radius, R, of the base of the object;
estimating a second angle, γ₂, based on fitting the second measurement data to the surface model; and
determining the axis tilt angle based on the first angle and the second angle.

31. (canceled)

32. (canceled)

33. (canceled)
